(19) United States
(12) Patent Application Publication
(10) Pub. No.: US 2001/0025376 A1
(43) Pub. Date: Sep. 27, 2001

(54) Audio and/or video system, particularly for motor vehicles or home applications

(75) Inventor: Karl-Heinz Knobl, Biebertal (DE)

Correspondence Address: COHEN, PONTANI, LIEBERMAN & PAVANE, 551 Fifth Avenue, Suite 1210, New York, NY, 10176, US

(73) Assignee: Mannesmann VDO AG

(21) Appl. No.: 09/748,600

(22) Filed: Dec. 26, 2000

(30) Foreign Application Priority Data
Dec. 24, 1999 (DE) 199 63 155.7

(51) Int. Cl. H04N 7/18

(52) U.S. Cl. 725/74

(57) ABSTRACT

An audio/video system (A/V system) for motor vehicles includes a ring local area network, a plurality of assorted audio/video appliances (A/V appliances), one or more output units, a control unit, and at least one operating unit. The A/V appliances transmit information about their available audio/video presentations to the control unit via the network. The available A/V presentations are displayed on a display independently of the appliances and divided into classes. The result of this is an appliance-independent user interface on the basis of which the user can select the presentations independently of the appliances. The user chooses a presentation such as a radio station independently of which frequency or which A/V appliance (analog radio receiver or DAB receiver) is used to receive it. The control software is of modular design.

### BACKGROUND OF THE INVENTION

1. Field of the Invention

The invention relates to an audio/video system having a plurality of assorted audio/video appliances, in particular for motor vehicles or for home applications.

2. Description of the Related Art

Various audio appliances and occasionally also video appliances are presently used in motor vehicles today. These are frequently separate appliances which are not connected to one another and are therefore operated separately. Although the appliances are sometimes connected to one another, it is generally possible to connect only particular appliances from a particular manufacturer to one another, which restricts the user severely when expanding the system. In the future, more audio and/or video appliances (A/V appliances) will be used in motor vehicles. Besides the radio receivers with cassette players and CD players which are already frequently installed in motor vehicles today, other A/V appliances which may be used include, by way of example, DVD (Digital Versatile Disc) players, DAB (Digital Audio Broadcasting) receivers and TV tuners. In addition, the number of output media may be significantly increased by headphone connections at the individual seats or by a number of displays. However, the increase in types of appliances that are arranged in one motor vehicle increases the complexity of operating these appliances and compatibility issues increasingly arise as more appliances are added. For example, radio programs may be received using either a conventional analog radio receiver or a digital DAB receiver. Therefore, the user must decide from which source he wants to obtain the desired audio and/or video presentation (A/V presentation) and to select the presentation using the appropriate user interface.

PCT Publication No. WO 99/35009 discloses a motor vehicle computer system having an audio entertainment system. The computer system provides an audio manager API (Application Program Interface), which permits the system to control the various audio sources without needing to know the specific hardware and implementation details. The computer system operates using an open operating system, particularly Windows CE.

European Patent Publication No. EP 0 932 132 A2 discloses a navigation system for motor vehicles which is linked to multimedia applications via an interface. The interface is likewise an API. To connect the multimedia application to the navigation system independently of the specific platform for the system used, appropriately suitable programming languages which are known per se are used such as, for example, Java.

### SUMMARY OF THE INVENTION

The object of the invention is to provide an audio/video system (A/V system) including a plurality of audio and/or video appliances (A/V appliances) which is simple to operate and allows a user to select and use a selected audio/visual presentation of one of the plural A/V appliances.

The object of the present invention is achieved by an A/V system having a local area network containing a data network and a control bus and a plurality of nodes, a plurality of assorted A/V appliances respectively connected to the plural nodes of the local area network and designed for transmitting information about their available audio and/or video presentations (A/V presentations) via the local area network. The A/V presentations may, for example, include informative and/or entertainment presentations. The A/V system further includes at least one audio and/or visual output unit (A/V output unit) for audio and/or video signals, a control unit having a control program and a memory which stores the information about the available A/V presentations which have been transmitted to the control unit from the A/V appliances, an operating unit connected to the control unit, and a visual output unit which displays the information about the available A/V presentations independently of the A/V appliances, the display of information being divided into classes.

The local area network is arranged in a motor vehicle or a home. The local area network includes a data network and a control bus. In addition, the local area network has nodes to which the A/V appliances may be connected. The local area network may advantageously be in the form of a ring network, more specifically an optical ring network. In this context, particular preference is given to an inherently known optical network based on the optical technology standards Domestic Digital Bus (D2B) or Media Oriented Systems Transport (MOST). The essential features of MOST technology are optical data transmission via plastic optical fibers in a ring topology with a large bandwidth which is currently 22.5 Mbit/s. Both control commands and status information are transmitted. Furthermore, it is possible to transmit both data streams, for example for audio and video applications, and data packets for graphics or navigation.

Besides the currently available A/V appliances such as radio receivers, cassette players and CD players or CD changers which are in widespread use in motor vehicles, the A/V appliances contemplated by the present invention further include a TV tuner, a DVD, a DAB appliance, and any other A/V device which is installable in a moto vehicle. According to the present invention, the A/V appliances each transmit information about their available A/V presentations via the ring local area network. If the A/V appliance is a radio receiver, the information about the available A/V presentations includes, for example, the names of the radio stations which can be received and information about the presentations transmitted by the respective radio stations, such as news, sport reports, music, traffic reports, etc. This information is already being transmitted by today's radio stations in the (Radio Data System) RDS message. If the A/V appliance is a CD player, the information about the available A/V presentations may include the music titles on an inserted audio CD.

The A/V system has at least one A/V output unit and preferably includes a plurality of A/V output units. Besides the loudspeakers which are normally installed in the vehicle, the output units may include headphones at the individual seat positions in the motor vehicle. The individual headphones allow each passenger to receive an individual audio program. In addition, a plurality of displays may be provided in the motor vehicle such as, for example, a front display for the front seat passenger and a rear display for the rear seat passengers. In conjunction with the headphones, various video presentations may thus also be used by the passengers.

The central component of the A/V system according to the present invention is a control unit having a control program and a memory which stores the information about the available A/V presentations which have been transmitted from each of the A/V appliances to the control unit. At least one operating unit for the system is connected to the control unit. In addition, a visual output unit is connected to the control unit. The visual output unit may be one of the displays already mentioned above which is also used as an A/V output unit. However, the visual output unit may also be a separate display screen designed only for displaying the information required to operate the system. The separate display screen may, for example, be arranged on the at least one operating unit. According to the invention, the visual output unit displays the information about the available A/V presentations independently of the appliances and divides the information into classes. Since the display of information is independent of the various A/V appliances, the user is not required to look at each individual A/V appliance to select a desired A/V presentation. Instead, the user receives a full overview of the available A/V presentations divided into classes to achieve a clear mode of representation. The information about the class to which an A/V presentation belongs may be transmitted directly from the A/V appliances to the control unit. However, the information transmitted from the A/V appliances about the available A/V presentation may also be processed further in the control unit by a suitable computer program. For example, a radio receiver may transmit the information that it has a particular station available which transmits traffic information. However, the control unit may assign traffic information to a “Reports” class together with other information presentations, such as news.

In addition, an appliance may also transmit a plurality of information items about the content of an A/V presentation. By way of example, a radio station may be identified as a supplier of traffic reports, news and music. Accordingly, an individual A/V presentation may be represented in different classes. Such processing of the transmitted information is also performed by the control unit.

In a further embodiment, the information about the A/V presentations may be in an output form in which each class contains at least one subclass (i.e., option). In this embodiment, the classes, the options for a selected class and also names for the individual A/V presentations in the selected class and option are displayed. Both the class and the option are in the form of so-called prototypes, i.e. they can be expanded as desired. The classes may include “Type”, “Title” or “Station”. The options for the “Type” class may, for example, include “Action”, “Pop”, “Classical”, “News” etc. The associated names of the A/V presentations may, for example, be the name of a radio station or the title of a CD inserted into the CD player. If the “Title” class is selected, the options may comprise, for example, “CD”, “Side A” or “Side B” or a data medium name. Names of the A/V presentations in this regard are title names such as music titles. Options which may be cited for the “Station” class are “Radio” or “TV”, the names of the A/V presentations denoting the individual stations.

According to the present invention, the control unit is used to select one of the available A/V presentations independently of the appliances. If a user has selected a particular radio station at the control unit using the “Type” class and the “Pop” option, the radio station is automatically retrieved by the control unit and is output via the audio output unit without the user needing to know or select the receiving appliance.

The A/V system has a plurality of A/V output units for A/V signals which may be selected via the operating unit. Accordingly, the operator can change over from the “Loudspeakers” output unit to the “Headphones” output unit. If the A/V system has a plurality of operating units, conflicts may arise in which different users may choose different output units for the same A/V presentation or the same output unit for different A/V presentations. To avoid these conflicts, each operating unit has a priority allocated to it. A selection made using an operating unit having relatively low priority may be modified only by an operating unit having the same or higher priority. For example, the operating unit for the driver is assigned the highest priority and the operating unit for the front seat passenger is assigned the second highest priority, while the operating units for the rear seat passengers are assigned a relatively low priority. If the driver selects a station for the playback of traffic information and wants to have the traffic information output via the loudspeakers, then neither the front seat passenger nor the rear seat passengers can send another A/V presentation to the Loudspeakers output unit.

The same A/V presentations may be provided by different A/V appliances in the overall system. The same music title may be available on an inserted CD and on an audio cassette. The same radio station may be available both via the analog radio receiver and via the digital DAB system. In this case, the user can manually select which appliance is to output the chosen A/V presentation via the output unit. However, priorities may be assigned to the A/V appliances themselves. In this embodiment, if the same A/V presentation is available from a plurality of appliances, the A/V appliance with the highest priority is connected to the output unit. Thus, a higher priority may be allocated to the DAB receiver than to the analog radio receiver or a higher priority may be allocated to the CD player than to the cassette player because of the superior playback quality.

In addition, the A/V system according to the present invention reduces the volume of the output when the chosen A/V presentation is being changed so that the transition is made at a reduced volume. This is known as a “soft mute”. In this context, after a new selection is made, the volume is first reduced, the change of presentation to be output is then made, and finally the volume is increased back to the original value.

The local area network for the A/V system according to the present invention is an open system, i.e., appliances from a wide variety of manufacturers may be integrated. To this end, the system has virtual interfaces, such as the known Application Program Interfaces (APIs).

The control unit includes a control program with a plurality of service modules which are produced in a platform-independent language. In this case, the preferred programming language is Java and to the Java-based Jini™ technology from the company Sun Microsystems using object-oriented programming methods. Java programs are translated by a compiler into a so-called byte code which can be executed using any microprocessor having a byte code interpreter, which provides the desired flexibility in terms of different A/V appliances.

The control program contains a first service module (Provider Service) to ensure that a suitable audio or video appliance is selected for playing back the chosen A/V presentation.

In addition, a second service module (Terminal Service) is arranged for selecting and managing the output units. A third service module (Network Service) is used to connect the network's node addresses stipulated by the selection of second and third service modules, i.e., the Provider Service and of the Terminal Service. In addition, there is a fourth service module (Rendering Service), which requests the operation of the other service modules. The control program also contains a registration module for registering newly connected A/V appliances.

An inventive method according to the present invention for operating a local multimedia system having a plurality of assorted A/V appliances has the following method steps:

transmitting information about available A/V presentations from the A/V appliances to a control unit, the information including one or more classifications of the available A/V presentations,

processing the information about the available A/V presentations into classes independently of the appliances using the classifications,

outputting the information about the available A/V presentations which has been processed into classes independently of the appliances on a visual output unit,

selecting an A/V output unit which is suitable for playing back the A/V presentation selected independently of the appliances using an operating unit,

connecting the selected A/V appliance to the selected A/V output unit, and

playing back the selected A/V presentation via the selected A/V output unit.

The processed information about the available A/V presentations has, as already mentioned, a class, a subclass (option) and a name. In one specific embodiment, the control program in turn has the Provider Service module, the Terminal Service module, Rendering Service module, and the Network Service module already mentioned above. The class, option and name selected by a user are transferred to the Rendering Service module. The Rendering Service module queries the registration module for a provider (A/V appliance) which can play back the content of the selected A/V presentation. When the provider found, the type of medium and the node address of the found provider is supplied to the Rendering Service module. This information can be used to request a suitable A/V output unit via the Terminal Service module. Finally, the Network Service module receives the request to connect the two node addresses to one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic diagram of an A/V system having the ring network structure according to an embodiment of the present invention;

FIG. 2 is a front view of an operating unit with a display showing a first classification;

FIG. 3 is a view of the display as in FIG. 2 showing a second classification;

FIG. 4 is a view of a display as in FIG. 2 showing a third classification;

FIG. 5 is a view of a display having a second appliance-independent output format; and

FIG. 6 is a view of a display having a third appliance-independent output format.

### DETAILED DESCRIPTION OF THE PRESENTLY PREFERRED EMBODIMENTS

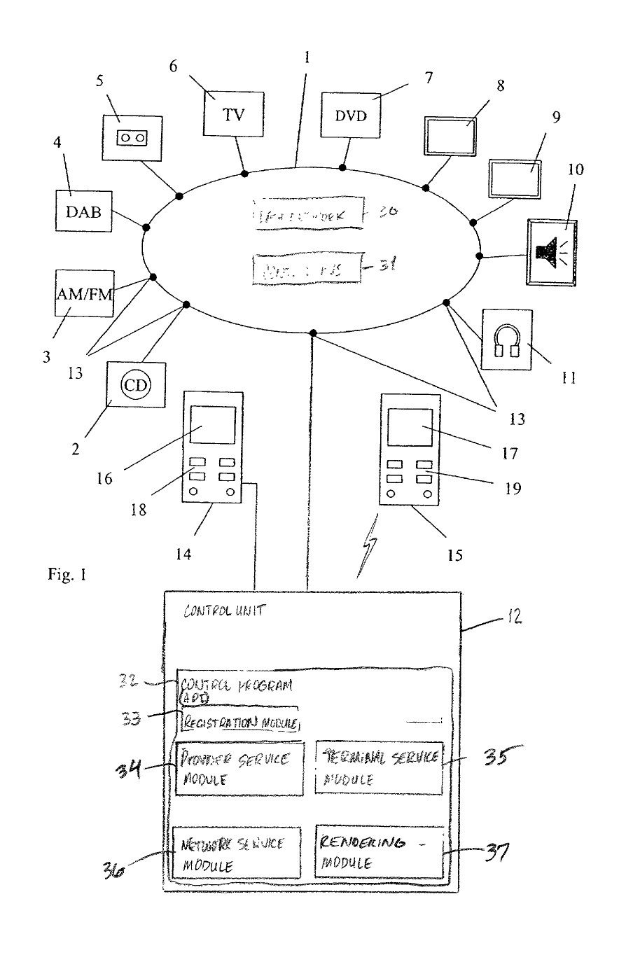

FIG. 1 shows the structure of an A/V system according to the present invention. An optical network 1 connects together a plurality of assorted A/V appliances 2-7, a plurality of output units 8-11 and a control unit 12, which are connected to nodes 13 in the optical network 1. The optical network 1 contains a media data network 30 which permits it to route data streams. In addition, the optical network 1 contains a control bus 31 for sending commands to the nodes 13 in the network 1. In the illustrative embodiment, the optical network 1 is an optical ring produced using Media Oriented Systems Transport (MOST) standard technology. Alternatively, other standards such as Domestic Digital Bus (D2B) may also be used. The A/V appliances 2-7 provided in the illustrative embodiment are, more specifically, a CD changer 2, an analog radio receiver 3, a DAB receiver 4 for digital radio reception, a cassette player 5, a TV receiver 6 and a DVD player 7. It should be noted that for purposes of this specification and claims, the phrase audio/visual (A/V) relates to devices that output audio and/or video signals. The output units provided include two monitors 8, 9, a loudspeaker system 10 and headphones 11. The control unit 12 has two operating units 14, 15 connected to it. The operating unit 14 is connected to the control unit 12 by a hard-wired connection and operating unit 15 is connected to the control unit 12 by a wireless connection. Of course, both operating units 14, 15 may be connected by a hard-wired connection or a wireless connection. The wireless connection may be effected, for example, via an infrared interface or via a short-haul radio link such as the Bluetooth method. presentation and at least one classification. For the CD changer 2, the title of the inserted CD and also the titles of the individual pieces of music and a classification for these pieces of music, such as “Rock”, “Pop” or “Folk music”, are transmitted. This information may be stored on the CD itself. However, the CD may also be identified by a key (e.g. TotalTrackTime*Tracks) and the information about the CD may be taken from a database.

For the analog radio receiver 3 and the DAB receiver 4, the names of the received radio stations and identifiers for the programs broadcast by these radio stations are transmitted. The program contents may, for example, have the classification such as News, Traffic reports, Music etc. This information is already transmitted from transmitter installations to the radio receiver for the most part using the Radio Data System (RDS) signal.

The TV receiver 6 also provides information about the receivable stations and their program contents. In addition, television programs may also be obtained over the Internet, for example, together with information about program contents.

The DVD player 7 transmits information including the title of a movie stored on the inserted data medium and the classification for the movie. This information may likewise be stored on the storage medium itself or may be obtained from a database.

In an alternative embodiment of the present invention, classifications for individual presentations such as radio stations may also be stored in the control unit, which obviates the need for transmission of the classification in this case. In addition, not all the connected A/V appliances 2-7 need to transmit detailed information regarding classifications for the available A/V presentations. For example, it may be sufficient for the CD changer 2 to transmit the titles of the music such as “Title 1”, “Title 2”.

The information transmitted from the A/V appliances 2-7 about the available A/V presentations is processed further in the control unit 12. This allows an A/V presentation such as a radio station to be assigned to a plurality of classes. The classified A/V presentations are displayed on displays 16, 17 on the operating units 14, 15 independently of the appliances. The keypads 18, 19 may be used to select one of the A/V presentations. In addition, the output unit may also be chosen. This information is again transmitted to the control unit 12. The control unit 12 then selects one of the A/V appliances 2-7 which has the desired A/V presentation available. A desired radio station may, for example, be provided both via the analog radio receiver 3 and via the DAB receiver 4. Each of the A/V appliances is assigned a priority. Therefore, when the desired presentation is provided by a plurality of the A/V appliances 2-7, the A/V appliance having the highest priority is selected. Stipulation of such priorities is always useful when a plurality of appliances have similar presentations available. In general, the A/V appliance expected to have the highest playback quality is assigned the highest priority and will be selected. The A/V appliance selected by the control unit 12 is then connected to the selected output unit. For an audio playback, the output unit may be the headphones 11. The program from the radio transmitter chosen by the operator is now transmitted from the DAB receiver 4 to the headphones 11 and is output via the latter, for example.

A control program 32 runs the control unit 12 and is of modular design. The control program contains a module called the registration module 33, where all the available services of the system are registered. The services required are also requested in the register. If the user has selected an A/V presentation, then the class, the option and the name of this presentation are transferred to the so-called “Rendering Service” module 37. The Rendering Service module 37 asks the Provider Service module 34 for a provider, i.e., one of the A/V appliances 2-7 which can play back the selected A/V presentation. The A/V appliance which is found by the “Provider Service” module 34 supplies the type of medium and the node address to the Rendering Service module 37. This information is used to request a suitable A/V output unit via the Terminal Service module 35 stipulating the A/V output unit. If a plurality of output units are available, the user chooses the desired output which is accepted taking into account possible priorities. Finally, a further module of the control program called the Network Service module 36 receives a request from the Rendering Service module 37 to connect the two node addresses for the selected A/V appliance and for the selected output unit.

The operating units 14, 15 are also used to enter the Start, Stop and Volume information and to forward this information to the appropriate A/V appliance and/or output unit. In the illustrative embodiment, two operating units 14, 15 are provided. The operating unit 14 may be permanently installed in the vehicle and is allocated to the vehicle driver. The operating unit 15 is a remote control which may also be used by any of the passengers. The operating units 14, 15 are provided with a priority, the operating unit 14 associated with the vehicle driver having a higher priority than the operating unit 15. Requests made using the operating unit 14 cannot be overwritten by the operating unit 15. Such a hierarchical arrangement of the operating units avoids conflicts when selecting A/V appliances or output units.

In addition, the A/V system of FIG. 1 may also include a navigation system for motor vehicles. The CD changer 2 may therefore also be used for reading map data stored on a CD.

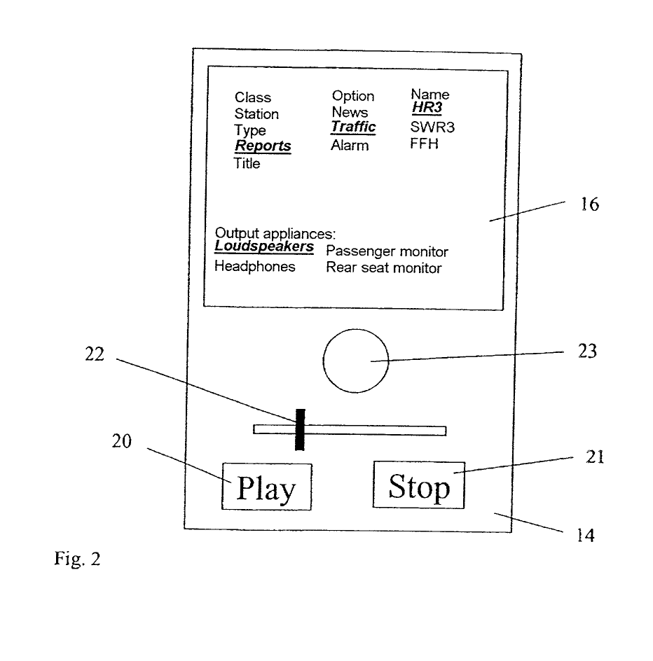

According to the present invention, the A/V presentations are divided into classes and are displayed independently of the appliances for the purpose of selection. This can be seen in more detail from FIG. 2 which shows the operating unit 14. The display 16 shows the available classes “Station”, “Type”, “Reports” and “Title”. Reports may, for example, include information which is not continuously available, i.e., information which is not available as a continuous data stream. In the example shown in FIG. 2, the “Reports” class has been selected. The selection of the “Reports” class is shown in FIG. 2 by underlining. In actual operating units, the selected class may be identified in various ways, for example using a different color or using a colored background. The display 16 shows the options available for the selected “Reports” class. These options are the “News”, “Traffic” and “Alarm”. The “Traffic” option has been selected in the illustrative embodiment shown. This option denotes data sources providing information about current traffic holdups. The column under the heading Name now lists the data suppliers available for the “Traffic” option. In the illustrative embodiment, these are three radio stations HR3, SWR3 and FFH. The station HR3 has been selected. In this context, the selection is made independently of the appliances. That is, the user does not need to think about which of the available A/V appliances is used to present and receive the supplier of traffic reports HR3.

The bottom area of the display 16 lists the available output units which include the vehicle's loudspeaker system, headphones, a monitor on the front seat passenger's side and a monitor for the rear seats. In FIG. 2, the output appliance chosen was the loudspeaker, and hence an audio output source.

By showing the available A/V presentations, put into order by class, option and name, and listing the available output appliances, an appliance-independent user interface is created. This allows the user to operate all appliances using one interface so that the user does not have to tackle different operating concepts for the individual appliances. In other words, the present invention allows the various A/V appliances 2-7, which may be made by different manufacturers, to operated as a system, not as individual components. In this case, a wide variaty of classes and options may be used as well as a wide variety of difference appliances. The type of A/V appliances are limited only by which can be connected in the overall system. The concept is implemented in software terms using the inherently known platform-independent programming language Java or another appropriately suitable programming language, or using Jini™ technology, which is based on Java.

Besides the display 16, the operating unit 14 has operating elements 20 to 23. The operating element 20 is for starting playback and the operating element 21 is for ending playback. Operating element 22 is for setting the volume and the operating element 23 may be used to indicate and select the selection options shown on the display 16. The operating element 23 may, for example, be a rotary/push-in controller.

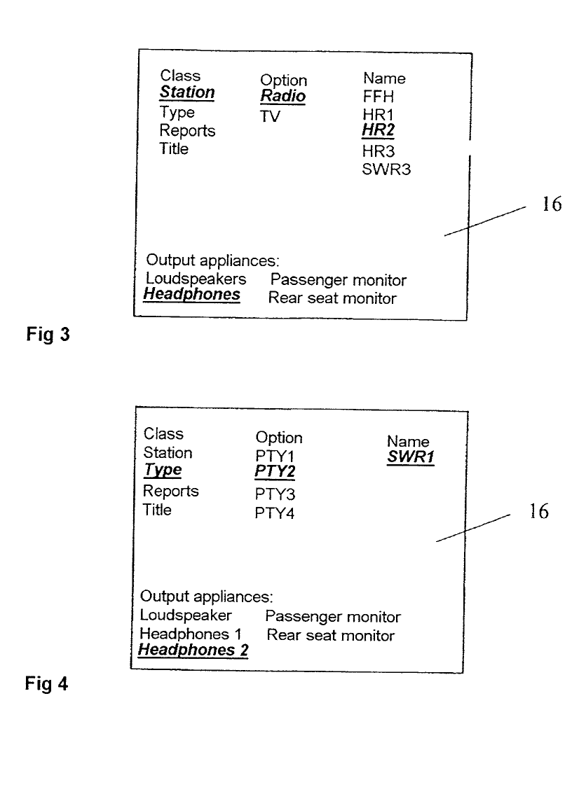

FIG. 3 shows the display 16, when a different class and option are selected. In this case, the “Station” class has been selected. The “Station” class includes the two options “Radio” and “TV”. For the “Radio” selection shown here, the Name column again lists the available radio stations.

FIG. 4 shows the display 16 in which the “Type” class has been selected. The “Type” class contains a number of options, denoted “PTY1” to “PTY4”. This abstract manner of portrayal involves the classifications, known from the RDS system, for radio stations' program contents. Instead of the notation “PTY1” to “PTY4”, a clear text display may also be used. The conversion from the RDS notation to the clear text display may be done in the control unit. In FIG. 4, the radio station providing the desired option “PTY2” is then displayed in turn under Name. The output appliance chosen, in this example, was “Headphones 2”.

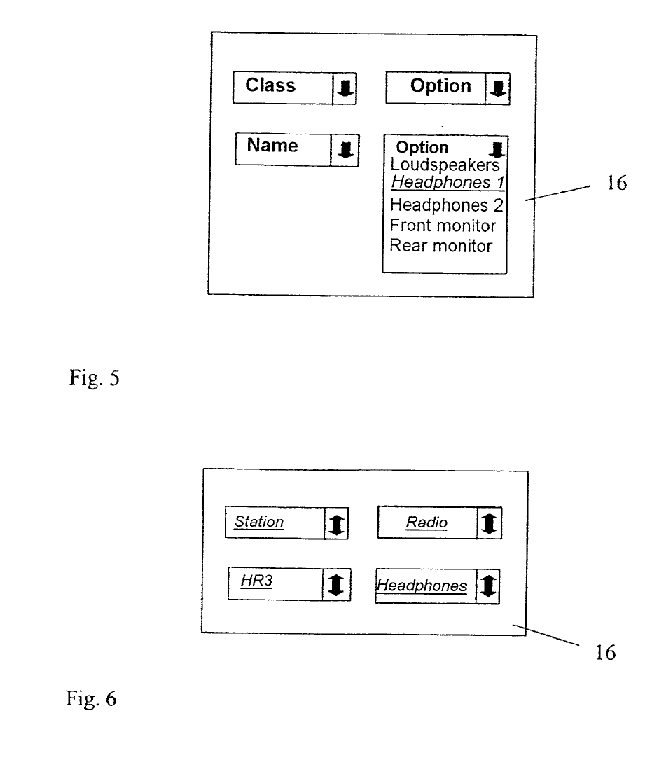

FIG. 5 shows the display 16 with a different output format. In this format, each of the fields Class, Option, Name and Output unit has an associated pull-down menu. This format is known from PC applications. The menus may be opened by selecting the menu. Once the menu is selected, the contents of that menu may be made. In the example, the menu for the output units is open.

FIG. 6 shows a further output format for the display 16. The fields for Class, Option, Name and Output unit have an associated window on the display, with a respective field element now being displayed. The field elements can be browsed by scrolling through the different lists of fields and selected.

The invention has been explained in more detail with the aid of an illustrative embodiment. The person skilled in the art will be able to make modifications, particularly with regard to the network specifically used or to the implementation of the control program in terms of software, without departing from the invention's novel basic idea.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An audio/video system, comprising:
a local area network having a data network, a control bus, and a plurality of nodes;
a plurality of audio/video appliances each having available audio/video presentations, said audio/video appliances respectively operatively connected to said plural nodes for transmitting information about the available audio/video presentations to said local area network;
at least one audio/video output unit for outputting audio/video signals;
a control unit having a control program and a memory which stores the information about the audio/video presentations transmitted by said audio/video appliances;
an operating unit connected to said control unit; and
a visual output unit operatively arranged for displaying the information about the available audio/video presentations independently of the audio/video appliances and dividing the information into classes.

2. The audio/video system of claim 1, wherein each class includes at least one subclass and wherein said audio/visual output unit displays the classes, the subclasses for a selected class and names for ones of said audio/video presentations in a selected class and subclass.

3. The audio/video system of claim 1, wherein said operating unit comprises means for selecting a selected one of the available audio/video presentations independently of the appliances and means for automatically retrieving the selected one of the available audio/video presentations using said control unit.

4. The audio/video system of claim 1, wherein said at least one audio/video output unit further comprising a plurality of audio/video output units for outputting audio/video signals.

5. The audio/video system of claim 4, wherein said operating unit comprises means for selecting one of said plural audio/visual output units.

6. The audio/video system of claim 1, further comprising a plurality of operating units connected to said control unit.

7. The audio/video system of claim 6, wherein each of said plural operating units is assigned a priority.

8. The audio/video system of claim 7, wherein a selection made using one of said plural operating units having a relatively high priority is prevented from being modified by another operating unit having a lower priority.

9. The audio/video system of claim 3, wherein said control unit is operatively arranged for assigning a priority to each of said plural audio/video appliances.

10. The audio/video system of claim 9, wherein at least two of said plural audio/video appliances have the selected one of the available audio/video presentations and said control unit comprises means for connecting the one of said at least two of said plural audio/video appliances having the highest priority to said at least one audio/video output unit.

11. The audio/video system of claim 3, wherein said control unit comprises means for reducing a volume when the selected one of the available audio/video presentations is changed.

12. The audio/video system of claim 1, wherein said operating unit comprises a start playback function, a stop playback function and a change volume function.

13. The audio/video system of claim 1, wherein said local area network comprises an optical ring network.

14. The audio/video system of claim 1, wherein said audio/video system is in a motor vehicle.

15. The audio/video system of claim 14, wherein at least one of said plural audio/video appliances is operatively arranged for reading map data for a navigation system.

16. The audio/video system of claim 1, wherein said audio/video system comprises a home multimedia system.

17. The audio/video system of claim 1, wherein one of said classes comprises radio and TV stations.

18. The audio/video system of claim 1, wherein one of said classes comprises a type of audio/video presentations.

19. The audio/video system of claim 1, wherein one of said classes comprises music titles.

20. The audio/video system of claim 1, wherein one of said classes is for information which is not continuously available.

21. The audio/video system of claim 1, wherein an audio/video presentation is assigned to a plurality of classifications.

22. The audio/video system of claim 1, wherein said local area network comprises an open system.

23. The audio/video system of claim 1, wherein wherein said control unit comprises virtual interfaces for each of said plural audio/video appliances.

24. The audio/video system of claim 1, wherein said control program comprises a plurality of service modules.

25. The audio/video system of claim 24, wherein said plural service modules comprise:
a first service module for selecting a suitable audio/video appliance for playing back the selected audio/video presentation;
a second service module for selecting and managing said at least one output unit;
a third service module for connecting the network's node addresses stipulated by the selections of the first and second service modules; and
a fourth service module which requests the functions of said first, second, and third service modules.

26. The audio/video system of claim 1, wherein said control program comprises a registration module for registering newly connected audio/video appliances.

27. A method for operating a local multimedia system having a plurality of audio/video appliances, including the steps of:
(a) transmitting information about available audio/video presentations from the audio/video appliances to a control unit, the information including one or more classifications of the audio/video presentations;
(b) processing the information about the available audio/video presentations into classes using the classifications independently of the appliances;
(c) outputting the information about the available audio/video presentations which has been processed into classes independently of the appliances onto a visual output unit;
(d) selecting an audio/video appliance which is suitable for playing back a selected audio/video presentation;
(e) connecting the selected audio/video appliance to an output unit; and
(f) playing back the selected audio/video presentation via the output unit.

28. The method of claim 27, wherein said step (a) comprises transmitting a classification, a subclass and a name by the audio/video appliances as information about the available audio/video presentation.

29. The method of claim 27, wherein said step (e) comprises selecting a selected audio/video output unit from a plurality of available audio video output units using the operating unit and connecting the selected audio/video output unit to the audio/video appliance selected in said step (d) by the control unit.

30. The method of claim 27, further comprising the step of assigning a priority to each of the operating units, and modifying a selection made using a first operating unit with a first priority only if it is done using an operating unit with the same or higher priority.

31. The method of claim 27, further comprising the step of assigning priorities to the audio/video appliances and said step (d) comprises selecting, by the control unit, the audio/video appliance with the selected audio/video presentation and which has the highest priority.

32. The method of claim 27, further comprising the steps of changing the currently selected audio/visual presentation using the operating unit;
selecting, by the control unit, the audio/video appliance which is suitable for playing back the newly selected audio/video presentation;
reducing the volume of the audio output unit from an original;
connecting the newly selected audio/video appliance to the audio output unit;
outputting the newly selected audio/video presentation via the audio output unit; and
returning the volume back to the original level.

33. The method of claim 27, wherein said step (a) comprises transmitting the information in an optical local area network.

34. The method of claim 27, wherein the classifications include a classification for radio and TV stations, a classification for the type of audio and/or video presentation available, a classification for music titles, and a classification for information which is not continuously available.

35. The method of claim 34, wherein said step (a) comprises transmitting the information about an available audio/video presentation including more than one classification, and allocating the audio/video presentation to more than one class on the basis of the more than one classifications.

36. The method of claim 27, wherein the number of classes in said step (b) is expandable.

37. The method of claim 27, further comprising the step of connecting the audio/video appliances and the control unit by virtual interfaces before said step (a).

38. The method of claim 27, wherein said step (a) comprises transmitting the information to the control unit which includes a control program having a plurality of service modules.

39. The method of claim 38, wherein said step (d) comprises selecting a suitable audio/video appliance for playing back the selected audio/video presentation by a first service module of the control program.

40. The method of claim 39, wherein wherein said step (e) comprises selecting the output unit managing the output unit by a second service module.

41. The method of claim 40, further comprising the step of connecting the audio/video appliance selected by the first service module and the output unit selected by the second service module by a third service module.

42. The method of claim 41, further comprising the step of requesting services of the first, second, and third service modules by a fourth service module.

43. The method of claim 27, further comprising the step of automatically registering a newly introduced audio/video appliance newly introduced into the multimedia system in a registration module.
